(19) United States
(12) Patent Application Publication
(10) Pub. No.: US 2023/0131491 A1
(43) Pub. Date: Apr. 27, 2023

(54) SOLID-STATE IMAGING DEVICE, IMAGING DEVICE, AND DISTANCE MEASUREMENT DEVICE

(71) Applicant: Panasonic Intellectual Property Management Co., Ltd., Osaka (JP)

(72) Inventors: Shigetaka KASUGA, Osaka (JP); Masaki TAMARU, Kyoto (JP); Yugo NOSE, Kyoto (JP)

(21) Appl. No.: 18/069,683

(22) Filed: Dec. 21, 2022

Related U.S. Application Data
(63) Continuation of application No. PCT/JP2021/024716, filed on Jun. 30, 2021.

(30) Foreign Application Priority Data
Jul. 30, 2020 (JP) 2020-128845

(51) Int. Cl. H04N 25/77; G01S 17/894; G01S 7/4863; H04N 25/78; H04N 25/703; H04N 13/254

(52) U.S. Cl. CPC H04N 25/77; G01S 17/894; G01S 7/4863; H04N 25/78; H04N 25/703; H04N 13/254

(57) ABSTRACT

A solid-state imaging device includes: pixels; a first sample-and-hold circuit provided per column and generating a first differential voltage that is a difference between a first reset voltage and a first signal voltage output from a first pixel disposed in a corresponding column among the pixels; a second sample-and-hold circuit provided per column and generating a second differential voltage that is a difference between a second reset voltage and a second signal voltage output from a second pixel disposed in the corresponding column among the pixels and different from the first pixel; and an A/D conversion circuit provided per column and converting, into digital signals, a first voltage based on the first differential voltage output from the first sample-and-hold circuit disposed in the corresponding column and a second voltage based on the second differential voltage output from the second sample-and-hold circuit disposed in the corresponding column.

### CROSS REFERENCE TO RELATED APPLICATIONS

This is a continuation application of PCT International Application No. PCT/JP2021/024716 filed on Jun. 30, 2021, designating the United States of America, which is based on and claims priority of Japanese Patent Application No. 2020-128845 filed on Jul. 30, 2020. The entire disclosures of the above-identified applications, including the specifications, drawings and claims are incorporated herein by reference in their entirety.

### FIELD

The present disclosure relates to a solid-state imaging device, an imaging device, and a distance measurement device.

### BACKGROUND

Solid-state imaging devices (image sensors) that convert light into electric signals are used in various devices, such as smartphones, surveillance cameras, in-vehicle cameras, cameras for medical use, digital video cameras, and digital still cameras.

In a solid-state imaging device, correlated double sampling (CDS) processing is performed to calculate a differential voltage between a reset voltage and a signal voltage, and analog-to-digital conversion processing is performed (for example, see Patent Literature (PTL) 1 and PTL 2).

### CITATION LIST

### Patent Literature

PTL 1: Japanese Patent No. 5953074
PTL 2: Japanese Patent No. 4442515

### SUMMARY

### Technical Problem

Such a solid-state imaging device is desired to reduce the power consumption.

### Solution to Problem

A solid-state imaging device according to one aspect of the present disclosure includes: a plurality of pixels that are arranged in a matrix and photoelectrically convert incident light; a first sample-and-hold circuit that is provided per column and generates a first differential voltage, the first differential voltage being a difference between a first reset voltage and a first signal voltage that are output from a first pixel disposed in a corresponding column among the plurality of pixels; a second sample-and-hold circuit that is provided per column and generates a second differential voltage, the second differential voltage being a difference between a second reset voltage and a second signal voltage that are output from a second pixel disposed in the corresponding column among the plurality of pixels, the second pixel being different from the first pixel; and an analog-to-digital conversion circuit that is provided per column and converts a first voltage and a second voltage into digital signals, the first voltage being based on the first differential voltage output from the first sample-and-hold circuit disposed in the corresponding column, the second voltage being based on the second differential voltage output from the second sample-and-hold circuit disposed in the corresponding column.

### Advantageous Effects

The present disclosure provides a solid-state imaging device, an imaging device, or a distance measurement device that can reduce power consumption.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram of an imaging device according to Embodiment 1.

FIG. 2 is a circuit diagram of a pixel, etc. according to Embodiment 1.

FIG. 3 is a circuit diagram of a CDS circuit according to Embodiment 1.

FIG. 4 is a circuit diagram of an A/D conversion circuit according to Embodiment 1.

FIG. 5 is a circuit diagram of a comparator according to Embodiment 1.

FIG. 6 is a diagram schematically illustrating a procedure of CDS processing and A/D conversion processing according to Embodiment 1.

FIG. 7 is a diagram illustrating an example of signal waveforms of a solid-state imaging device according to Embodiment 1.

FIG. 8 is a diagram illustrating an example of a pixel output signal according to Embodiment 1.

FIG. 9 is a diagram illustrating an example of a voltage of node N1 according to Embodiment 1.

FIG. 10 is a diagram illustrating an example of a voltage of node N3 according to Embodiment 1.

FIG. 11 is a diagram illustrating an example of a voltage of CDSOUT according to Embodiment 1.

FIG. 12 is a diagram illustrating an example of reference voltage RAMP according to Embodiment 1.

FIG. 13 is a diagram illustrating an example of a voltage of node N4 according to Embodiment 1.

FIG. 14 is a diagram illustrating an example of a voltage of node N5 according to Embodiment 1.

FIG. 15 is a diagram illustrating an example of a voltage of node N4 and a voltage of node N5 according to Embodiment 1

FIG. 16 is a diagram illustrating an example of a voltage of node N4 and a voltage of node N5 according to Embodiment 1.

FIG. 17 is a block diagram of a distance measurement device according to Embodiment 2.

### DESCRIPTION OF EMBODIMENTS

Hereinafter, a solid-state imaging device, etc. according to the present embodiment will be described with reference to the drawings. However, description detailed more than necessary may be omitted. For example, detailed description of well-known matters or repeated description of substantially the same configurations may be omitted. This is to avoid unnecessary redundancy in the following description and facilitate the understanding of those skilled in the art. Note that the attached drawings and the following description are provided in order to facilitate sufficient understanding of those skilled in the art, and thus are not intended to limit the subject matters recited in the claims.

### Embodiment 1

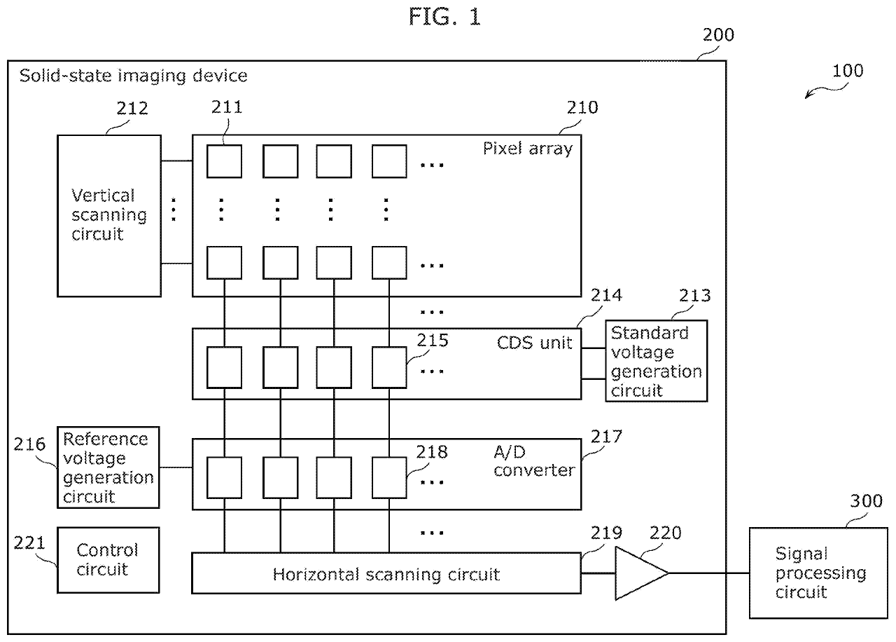

First, a configuration of an imaging device and a configuration of a solid-state imaging device according to the present embodiment will be described. FIG. 1 is a block diagram of imaging device 100 according to Embodiment 1. Imaging device 100 is, for example, a camera system, and includes solid-state imaging device 200 and signal processing circuit 300. For example, solid-state imaging device 200 is a complementary metal-oxide semiconductor (CMOS) image sensor. Solid-state imaging device 200 includes pixel array 210, vertical scanning circuit 212, standard voltage generation circuit 213, CDS unit 214, reference voltage generation circuit 216, A/D converter 217, horizontal scanning circuit 219, output circuit 220, and control circuit 221.

Pixel array 210 includes a plurality of pixels 211 arranged in a matrix (array). Each pixel 211 generates a pixel output signal, which is an electric signal, by photoelectrically converting incident light. Vertical scanning circuit 212 controls row addresses and row scanning.

Standard voltage generation circuit 213 generates first standard voltage VREF1 and second standard voltage VREF2, and supplies the generated first standard voltage VREF1 and second standard voltage VREF2 to CDS unit 214.

CDS unit 214 performs correlation double sampling (CDS) processing on the pixel output signal to generate a differential voltage corresponding to a difference between a reset voltage and a signal voltage. CDS unit 214 includes a plurality of CDS circuits 215 each provided per column. Each CDS circuit 215 performs the CDS processing on the pixel output signals output from pixels 211 in a corresponding column.

Reference voltage generation circuit 216 generates reference voltage RAMP. A/D converter 217 performs A/D conversion processing that converts a differential signal, which is an analog signal, into a digital signal using reference voltage RAMP. A/D converter 217 includes a plurality of A/D conversion circuits 218 each provided per column. Each A/D conversion circuit 218 performs the A/D conversion processing on the differential voltages output from CDS circuit 215 in the corresponding column.

Horizontal scanning circuit 219 controls column addresses and the column scanning. Output circuit 220 outputs the digital signals output from horizontal scanning circuit 219 to signal processing circuit 300, as video data.

Control circuit 221 generates various control signals, and controls operation of, for example, vertical scanning circuit 212, CDS unit 214, reference voltage generation circuit 216, A/D converter 217, and horizontal scanning circuit 219.

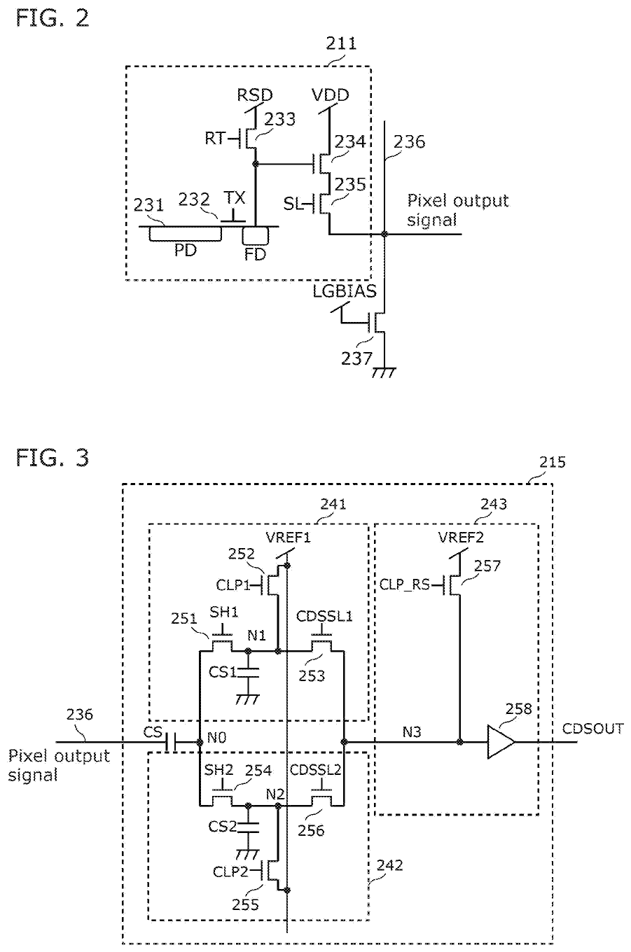

FIG. 2 is a circuit diagram of pixel 211, etc. As illustrated in FIG. 2, pixel 211 includes photodiode 231, transfer transistor 232, reset transistor 233, amplification transistor 234, and selection transistor 235. Photodiode 231 is a photoelectric converter that photoelectrically converts incident light into an electric signal (signal charge).

Transfer transistor 232 is connected between photodiode 231 and floating diffusion (FD). The on and off of transfer transistor 232 is controlled by signal TX. Reset transistor 233 is connected between the voltage line to which reset voltage RSD is applied and the FD. The on and off of reset transistor 233 is controlled by signal RT.

Amplification transistor 234 and load transistor 237 form a source follower circuit. Amplification transistor 234 outputs, to pixel signal line 236, a pixel output signal in accordance with the voltage of the FD. Selection transistor 235 is connected between amplification transistor 234 and pixel signal line 236. The on and off of selection transistor 235 is controlled by signal SL.

Pixel signal line 236 is provided per column and is connected to a plurality of pixels 211 disposed in a corresponding column. Load transistor 237 is provided per column and is connected to pixel signal line 236 in the corresponding column.

FIG. 3 is a circuit diagram of CDS circuit 215. CDS circuit 215 includes first sample-and-hold circuit 241, second sample-and-hold circuit 242, output circuit 243, and capacitor CS. First sample-and-hold circuit 241 generates a first differential voltage corresponding to a difference between a first reset voltage and a first signal voltage output from each of first pixels included in pixels 211 disposed in the corresponding column. Second sample-and-hold circuit 242 generates a second differential voltage corresponding to a difference between a second reset voltage and a second signal voltage output from each of second pixels different from the first pixels and included in pixels 211 disposed in the corresponding column. For example, the first pixels are pixels 211 in one of odd rows or even rows, and the second pixels are pixels 211 in the remaining one of the odd rows or the even rows. Note that, here, the odd rows and the even rows may be the odd-numbered or even-numbered rows in terms of the physical locations, or may be the odd-numbered or even-numbered rows in terms of the readout order (row scanning order).

Output circuit 243 generates a first voltage and a second voltage by offsetting the first differential voltage and the second differential voltage using second standard voltage VREF2.

Capacitor CS is connected between pixel signal line 236 and node NO. First sample-and-hold circuit 241 includes transistors 251, 252, and 253, and capacitor CS1. Transistor 251 is connected between node NO and node N1. The on and off of transistor 251 is controlled by signal SH1. Transistor 252 is connected between the voltage line to which first standard voltage VREF1 is supplied and node N1. The on and off of transistor 252 is controlled by signal CLP1. Transistor 253 is connected between node N1 and node N3. The on and off of transistor 253 is controlled by signal CDSSL1. Capacitor CS1 is connected to node N1.

Second sample-and-hold circuit 242 includes transistors 254, 255, and 256, and capacitor CS2. Transistor 254 is connected between node NO and node N2. The on and off of transistor 254 is controlled by signal SH2. Transistor 255 is connected between the voltage line to which first standard voltage VREF1 is supplied and node N2. The on and off of transistor 255 is controlled by signal CLP2. Transistor 256 is connected between node N2 and node N3. The on and off of transistor 256 is controlled by signal CDSSL2. Capacitor CS2 is connected to node N2.

Here, transistor 251 and transistor 254 form a first selection circuit that selectively outputs the pixel output signal to one of first sample-and-hold circuit 241 or second sample-and-hold circuit 242. Furthermore, transistor 253 and transistor 256 form a second selection circuit that selectively outputs one of the first differential voltage or the second differential voltage to node N3.

Output circuit 243 includes transistor 257 and buffer circuit 258. Transistor 257 is connected between the voltage line to which second standard voltage VREF2 is supplied and node N3. The on and off of transistor 257 is controlled by signal CLP_RS.

Buffer circuit 258 includes an input terminal connected to node N3 and an output terminal connected to A/D conversion circuit 218. Buffer circuit 258 amplifies the voltage of node N3 and outputs the amplified voltage as voltage CDSOUT.

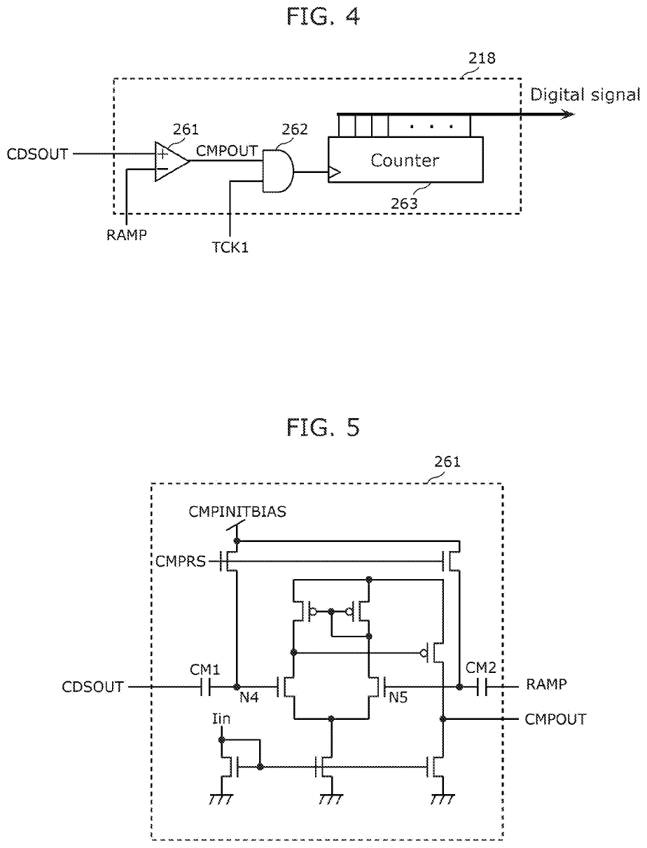

FIG. 4 is a circuit diagram of A/D conversion circuit 218. A/D conversion circuit includes comparator 261, AND circuit 262, and counter 263. Comparator 261 compares voltage CDSOUT and reference voltage RAMP and outputs signal CMPOUT indicating the comparison result. AND circuit 262 outputs a logical product of signal CMPOUT and clock TCK1 to counter 263. Counter 263 generates a digital signal by performing counting based on the logical product. FIG. 5 is a circuit diagram illustrating an example of a configuration of comparator 261.

Signal processing circuit 300 processes digital signals output by solid-state imaging device 200.

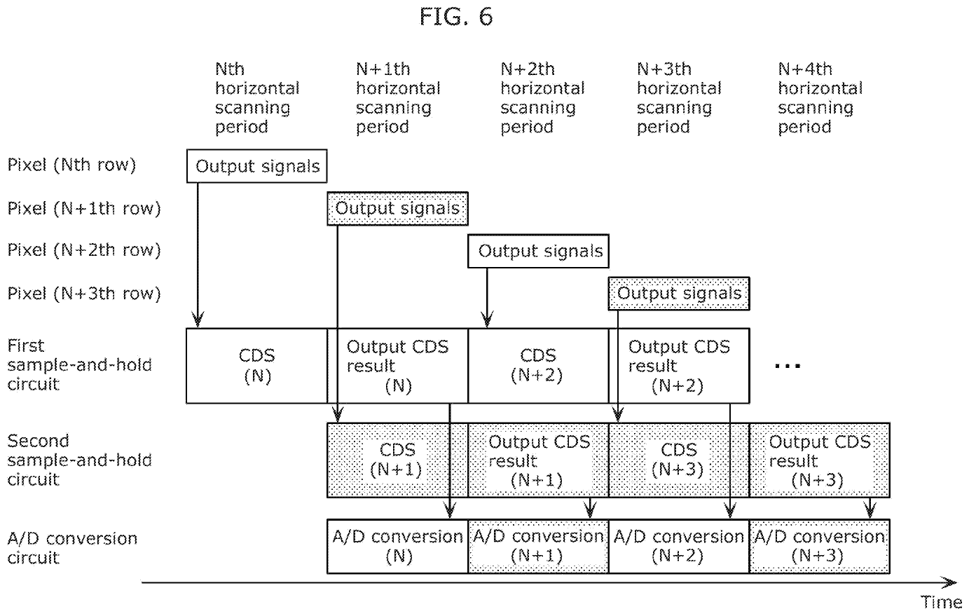

Next, operation of solid-state imaging device 200 according to the present embodiment will be described. FIG. 6 is a diagram schematically illustrating a procedure of the CDS processing and the A/D conversion processing in solid-state imaging device 200. Note that, for the sake of simplification, the processing for four rows of pixels is illustrated in the figure. Moreover, the horizontal scanning period illustrated in the figure is a period when one row is selected (pixel signal in one row is read out).

As illustrated in FIG. 6, signals of pixel 211 in an Nth row are output (the reset voltage and the signal voltage are output) in an Nth horizontal scanning period, and first sample-and-hold circuit 241 generates a differential voltage by performing the CDS processing for the pixel in the Nth row.

In the next N+1th horizontal scanning period, first sample-and-hold circuit 241 outputs the differential voltage of the pixel in the Nth row, and A/D conversion circuit 218 performs the A/D conversion processing on the differential voltage that has been output. Moreover, in this N+1th horizontal scanning period, signals of pixel 211 in the N+1th row are output, and second sample-and-hold circuit 242 generates a differential voltage by performing the CDS processing for the pixel in the N+1th row.

In the next N+2th horizontal scanning period, second sample-and-hold circuit 242 outputs the differential voltage of the pixel in the N+1th row, and A/D conversion circuit 218 performs the A/D conversion processing on the differential voltage that has been output. Moreover, in this N+2th horizontal scanning period, signals of pixel 211 in the N+2th row are output and first sample-and-hold circuit 241 generates a differential voltage by performing the CDS processing for the pixel in the N+2th row.

In this way, in the present embodiment, two sample-and-hold circuits enable parallel processing in which the A/D conversion processing is performed for one row and the CDS processing is performed for a next row. As a result, the duration of the CDS processing and the A/D conversion processing can be extended compared with the case where the CDS processing and the A/D conversion processing are performed in time sequence in one horizontal scanning period. With this, for example, the clock frequency of the A/D conversion processing can be lowered, and therefore power consumption can be reduced.

In general, power consumption P of a digital circuit is expressed as P=Ctot×Vdd²×Tclk, where Ctot is a total capacitance of the digital circuit, Vdd is a supply voltage, and Tclk is a drive frequency. Therefore, power consumption can be reduced by lowering the frequency. In addition, since the drive frequency of the entire peripheral circuit is also lowered, the difficulty of designing the delay margin in the layout decreases and yields can be improved.

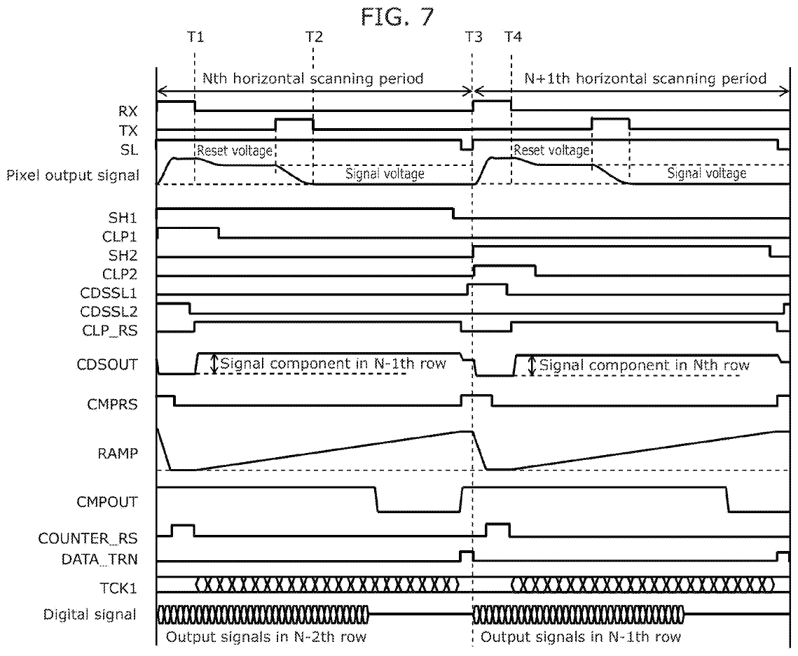

FIG. 7 is a diagram illustrating an example of signal waveforms of solid-state imaging device 200. In the present embodiment, the CDS processing and the A/D conversion processing are performed in parallel. This increases the proportion of the A/D conversion processing period (for example, the period when reference voltage RAMP monotonically increases [or decreases]) in one horizontal scanning period. For example, as illustrated in FIG. 7, the period when reference voltage RAMP increases monotonically accounts for half or more of one horizontal scanning period.

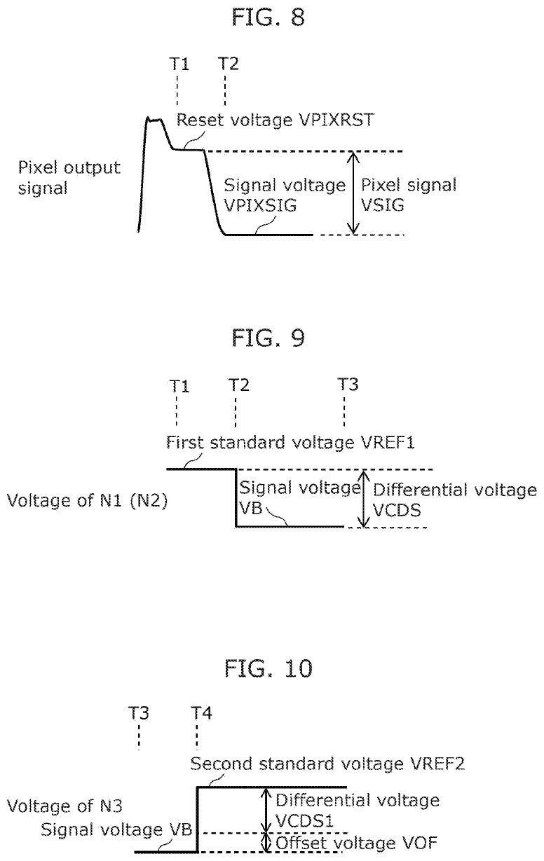

Hereinafter, each operation will be described in detail with reference to FIG. 7 and FIGS. 8 through 16. FIG. 8 is a diagram illustrating an example of a pixel output signal. First, as illustrated in FIGS. 7 and 8, in response to signal RT being on (high level), at time T1, reset voltage VPIXRST of the pixel in the Nth row is output as a pixel output signal.

Next, in response to signal TX being on, at time T2, the value of the pixel output signal decreases according to the value of the pixel signal (the amount of readout charge). In other words, signal voltage VPIXSIG corresponding to transferred signal charge is output as a pixel output signal. Here, pixel signal VSIG is expressed as VSIG=VPIXRST−VPIXSIG. Furthermore, the DC component of the pixel output signal is cut through capacitor CS and the pixel output signal is supplied to node NO.

FIG. 9 is a diagram illustrating an example of a voltage of node N1 illustrated in FIG. 3. At time T1, reset voltage VPIXRST and first standard voltage VREF1 are initialized through capacitor CS. At time T2, the voltage of node N1 becomes voltage VB after the voltage decreases by differential voltage VCDS that has been analog-CDS processed. Here, differential voltage VCDS is expressed as VCDS=VSIG×CS÷(CS+CS1), and signal voltage VB is expressed as VB=VREF1−VCDS.

Differential voltage VCDS, which is a difference between the reset voltage and the signal voltage, is stored in first sample-and-hold circuit 241.

Note that, although the operation of first sample-and-hold circuit 241 has been described here, second sample-and-hold circuit 242 operates in the same manner. In this case, differential voltage VCDS is expressed as VCDS=VSIG×CS÷(CS+CS2). Signal voltage VC, which is a voltage of node N2 corresponding to signal voltage VB, is expressed as VC=VREF1−VCDS. For example, CS2 is equal to CS1.

FIG. 10 is a diagram illustrating an example of a voltage of node N3 illustrated in FIG. 3. At time T3, node N3 is charged to voltage VB. At time T4, node N3 is charged to second standard voltage VREF2.

Here, VREF2−VB=VCDS1+VOF is satisfied. Offset voltage VOF is expressed as VOF=VREF2−VREF1. For example, VOF is a positive voltage. In other words, second standard voltage VREF2 is greater than first standard voltage VREF1. Differential voltage VCDS1 is a voltage corresponding to differential voltage VCDS and is approximately equal to differential voltage VCDS.

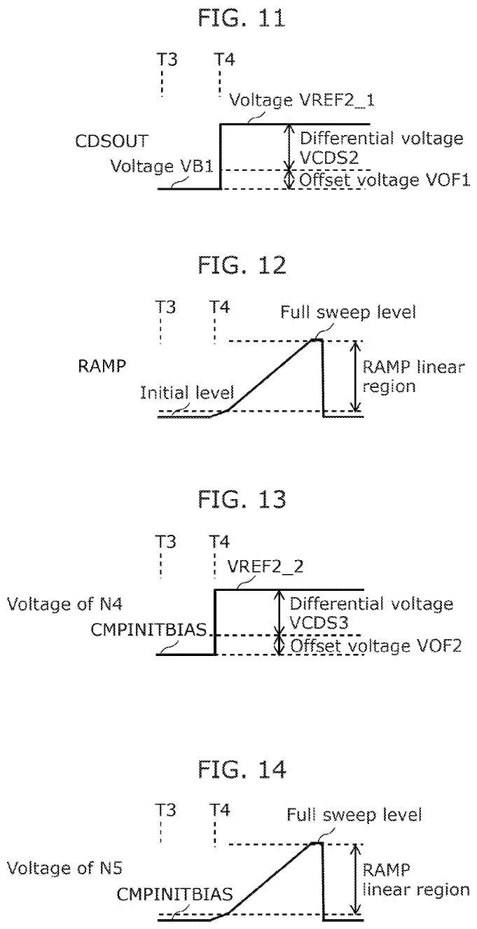

FIG. 11 is a diagram illustrating an example of a voltage of CDSOUT. Buffer circuit 258 generates a voltage of CDSOUT by performing impedance conversion on the voltage of node N3. At time T3, CDSOUT is charged to voltage VB1. Here, voltage VB1 is a voltage after voltage VB has passed through buffer circuit 258.

At time T4, CDSOUT is charged to voltage VREF2_1. Here, voltage VREF2_1 is a voltage after voltage VREF2 has passed through buffer circuit 258.

Here, VREF2_1−VB1=VCDS2+VOF1 is satisfied. Note that differential voltage VCDS2 is a voltage corresponding to differential voltage VCDS1 and is approximately equal to differential voltage VCDS1. Offset voltage VOF1 is a voltage corresponding to offset voltage VOF and is approximately equal to offset voltage VOF.

In the present embodiment, both (i) second standard voltage VREF2 for setting the offset voltage and (ii) signal voltage VB pass through buffer circuit 258, and are input to comparator 261 disposed downstream. This reduces the effects of temperature characteristics and so on compared with the case where, for example, second standard voltage VREF2 is supplied to comparator 261 through a different path.

In the present embodiment, no capacitive element other than parasitic capacitance is connected to node N3 (common node). This enables high-speed switching between the output signal of first sample-and-hold circuit 241 and the output signal of second sample-and-hold circuit 242. Therefore, the latency before the start of the A/D conversion processing can be reduced.

FIG. 12 is a diagram illustrating an example of reference voltage RAMP. At time T3, reference voltage RAMP is set to an initial level. At time T4, a sweep (monotonic increase) of reference voltage RAMP starts and reference voltage RAMP increases to the full sweep level. Note that reference voltage RAMP may be a voltage that monotonically decreases.

FIG. 13 is a diagram illustrating an example of a voltage of node N4 illustrated in FIG. 5. At time T3, node N4 is charged to voltage CMPINITBIAS, which is an initialization voltage of the input terminal of comparator 261.

The DC component of voltage of CDSOUT is cut through capacitor CM1, and the voltage of CDSOUT is supplied to node N4. At time T4, the voltage of node N4 is charged to voltage VREF2_2. Here, voltage VREF2_2 is a voltage corresponding to voltage VREF2_1. Moreover, VREF2_2−CMPINITBIAS=VCDS3+VOF2 is satisfied. Note that differential voltage VCDS3 is a voltage corresponding to differential voltage VCDS2 and is approximately equal to differential voltage VCDS2. Offset voltage VOF2 is a voltage corresponding to offset voltage VOF1 and is approximately equal to offset voltage VOF1. In other words, VREF2_2−CMPINITBIAS corresponds to VREF2_1−VB1, and is approximately equal to VREF2_1−VB1.

FIG. 14 is a diagram illustrating an example of a voltage of node N5 illustrated in FIG. 5. At time T3, node N5 is charged to voltage CMPINITBIAS, which is the initialization voltage of the input terminal of comparator 261.

The DC component of reference voltage RAMP is cut through capacitor CM2, and reference voltage RAMP is supplied to node N5. At time T4, the voltage of node N5 starts to change from voltage CMPINITBIAS according to the sweep of reference voltage RAMP.

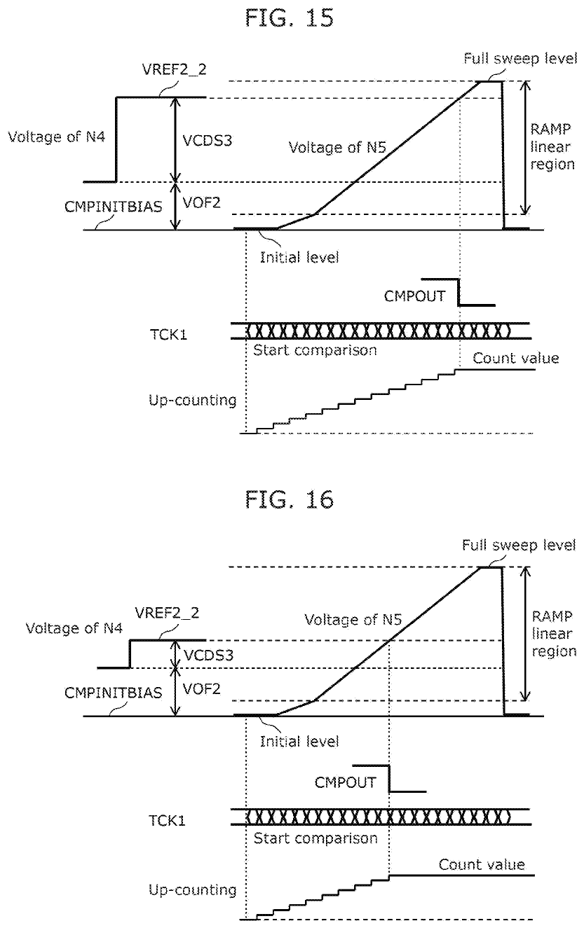

FIG. 15 is a diagram illustrating an example of a voltage of node N4 and a voltage of node N5. As illustrated in FIG. 15, counter 263 performs a counting operation until voltage VREF2_2 and the voltage of node N5 match. When voltage VREF2_2 and the voltage of node N5 match, counter 263, which is performing the counting operation synchronously with the reference voltage RAMP, stops. The count value at that time is the digital signal corresponding to the differential voltage.

Here, in the present embodiment, an offset voltage is added to the differential voltage by second standard voltage VREF2. This offset voltage is set such that voltage VREF2_2 is included in the best linearity range in which waveform distortion is small at reference voltage RAMP (voltage of node N5) (RAMP linear region illustrated in FIG. 15, for example). In other words, voltage VREF2_2 is included in the RAMP linear region with respect to any possible value of the differential voltage. This reduces the quantization error in the A/D conversion processing. Furthermore, this suppresses horizontal shading and fixed pattern noise (FPN) that may occur in A/D conversion circuit 218.

Moreover, pixels 211 may include optical black pixels (OB pixels) that are shielded from light. The offset voltage is a voltage indicating a difference between first standard voltage VREF1 and second standard voltage VREF2. When the differential voltage is zero, the offset voltage is output as a digital signal. In other words, solid-state imaging device 200 generates a digital signal indicating the offset voltage by performing the CDS processing and the A/D conversion processing on each of the pixel output signals from the OB pixels in the same manner as described above.

Signal processing circuit 300 disposed downstream subtracts the digital signal indicating the offset voltage from the digital signal of each pixel to obtain a digital signal corresponding to a true signal component. That is, signal processing circuit 300 may subtract a first digital signal from a second digital signal. The first digital signal and the second digital signal are included in the digital signals output from solid-state imaging device 200. The first digital signal is based on a signal obtained from an OB pixel. The second digital signal is based on a signal obtained from a pixel other than the OB pixel among pixels 211. As a result, a digital signal corresponding to a true signal component can be obtained when the quantization error is reduced using an offset voltage as described above.

FIG. 16 is a diagram illustrating another example of a voltage of node N4 and a voltage of node N5. In the example illustrated in FIG. 16, the signal voltage (VCDS3) is small compared with the example illustrated in FIG. 15. With this, voltage VREF2_2 matches the voltage of N5 at an early timing, and thus the up-counting stops at an early timing. Accordingly, a small value is output as a digital signal.

Furthermore, as illustrated in FIG. 7, the obtained digital signals are output in the next horizontal scanning period after the horizontal scanning period in which the A/D conversion processing has been performed. For example, the A/D conversion processing for the N−1 row is performed in the N horizontal scanning period, and the digital signals in the N−1 row are output in the N+1 horizontal scanning period. Note that signal COUNTER_RS illustrated in FIG. 7 is a signal that resets counter 263, and signal DATA_TRN is a signal that controls transfer of the digital signal from A/D converter 217 to horizontal scanning circuit 219.

As described above, solid-state imaging device 200 according to the present embodiment includes: first sample-and-hold circuit 241 that generates a first differential voltage corresponding to a difference between a first reset voltage and a first signal voltage that are output from a first pixel among a plurality of pixels 211; and second sample-and-hold circuit 242 that generates a second difference voltage corresponding to a difference between a second reset voltage and a second signal voltage that are output from a second pixel among the plurality of pixels 211. The second pixel is different from the first pixel. Since this makes it possible to perform the CDS processing and the A/D conversion processing in parallel, the duration of the CDS processing and the AD conversion processing can be extended. Therefore, the frequency of counter 263, etc. can be lowered when the number of bits of conversion is the same, for example. This reduces power consumption. In addition, this facilitates designing of delay margins in the wiring layout of the control signals, namely, the clock signal and the pulse signal.

Moreover, in the present embodiment, use of an analog CDS circuit (CDS circuit 215) makes it possible to perform the process of comparing voltage CDSOUT and reference voltage RAMP by comparator 261 in one step. Therefore, reference voltage generation circuit 216, which generates reference voltage RAMP, can be slowed down and power consumption can be reduced. In addition, because the slope of the reference voltage RAMP becomes gentle, the performance requirements of reference voltage generation circuit 216 are also eased. Therefore, the designing of reference voltage generation circuit 216 can be facilitated and the circuit size can be reduced.

In addition, since counter 263 may perform counting in one direction, i.e., one of down-counting or up-counting, it is possible to facilitate designing of the circuit of counter 263 and reduce the circuit size. Furthermore, these improve yields.

### Embodiment 2

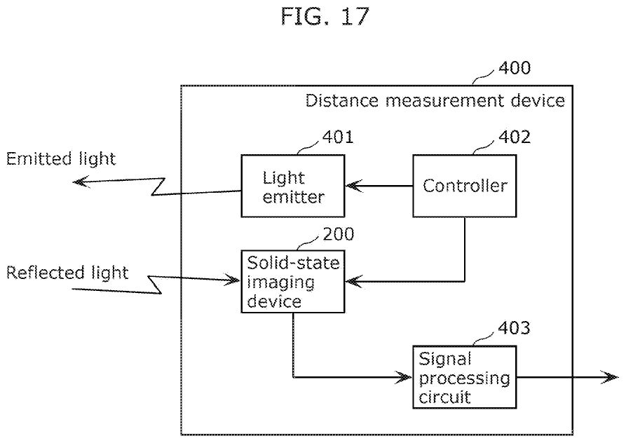

In the present embodiment, a distance measurement device including solid-state imaging device 200 described above will be described. FIG. 17 is a block diagram of distance measurement device 400 according to Embodiment 2. Distance measurement device 400 is a distance measurement device using Time of Flight (TOF), which measures the time taken from when light is emitted to an object until the light is reflected by the object and returns to the distance measurement device.

As illustrated in FIG. 17, distance measurement device 400 includes solid-state imaging device 200, light emitter 401, controller 402, and signal processing circuit 403.

Light emitter 401 emits light. Solid-state imaging device 200 is, for example, the solid-state imaging device described in Embodiment 1. Solid-state imaging device 200 receives reflected light of the light emitted from light emitter 401 and reflected, and generates digital signals (image). In other words, solid-state imaging device 200 receives light emitted from light emitter 401 and reflected by an object.

Controller 402 controls light emitter 401 and solid-state imaging device 200. Signal processing circuit 403 processes the digital signals output by solid-state imaging device 200. Specifically, signal processing circuit 403 generates a three-dimensional image including information in a depth direction by combining a plurality of images output from solid-state imaging device 200.

Note that a plurality of photodiodes 231 included in solid-state imaging device 200 may be avalanche photodiodes. In this case, each of pixels 211 includes a pixel circuit capable of photon counting. Since faint light can be detected by using avalanche photodiodes, avalanche photodiodes are suitable for distance measurement devices using TOF.

As described above, as illustrated in FIGS. 1 and 3, solid-state imaging device 200 according to the embodiment includes: a plurality of pixels 211 that are arranged in a matrix and photoelectrically convert incident light; first sample-and-hold circuit 241 that is provided per column and generates a first differential voltage, the first differential voltage being a difference between a first reset voltage and a first signal voltage that are output from a first pixel disposed in a corresponding column among the plurality of pixels 211; second sample-and-hold circuit 242 that is provided per column and generates a second differential voltage, the second differential voltage being a difference between a second reset voltage and a second signal voltage that are output from a second pixel disposed in the corresponding column among the plurality of pixels 211, the second pixel being different from the first pixel; and an analog-to-digital conversion circuit (A/D conversion circuit 218) that is provided per column and converts a first voltage and a second voltage into digital signals, the first voltage being based on the first differential voltage output from the first sample-and-hold circuit disposed in the corresponding column, the second voltage being based on the second differential voltage output from the second sample-and-hold circuit disposed in the corresponding column.

For example, as illustrated in FIGS. 1 and 3, solid-state imaging device 200 includes: standard voltage generation circuit 213 that generates first standard voltage VREF1 and second standard voltage VREF2, first standard voltage VREF1 corresponding to the first reset voltage and the second reset voltage and being input to first sample-and-hold circuit 241 and second sample-and-hold circuit 242; and output circuit 243 that generates the first voltage and the second voltage by offsetting the first differential voltage and the second differential voltage using second standard voltage VREF2.

For example, as illustrated in FIG. 3, output circuit 243 includes: first switching element (transistor 257) connected between (i) common node N3 to which the first differential voltage or the second differential voltage is selectively output and (ii) a second standard voltage line to which second standard voltage VREF2 is supplied; and buffer circuit 258 including an input terminal connected to common node N3 and an output terminal connected to the analog-to-digital conversion circuit (A/D conversion circuit 218).

For example, as illustrated in FIG. 3, no capacitive element other than parasitic capacitance is connected to common node N3.

For example, as illustrated in FIG. 3, solid-state imaging device 200 includes: pixel signal line 236 that is provided per column and is connected to a plurality of pixels 211 disposed in the corresponding column. First sample-and-hold circuit 241 includes: second switching element (transistor 251) connected between pixel signal line 236 in the corresponding column and first node N1; a third switching element (transistor 252) connected between a first standard voltage line to which first standard voltage VREF1 is supplied and first node N1; and a fourth switching element (transistor 253) connected between first node N1 and common node N3. Second sample-and-hold circuit 242 includes: a fifth switching element (transistor 254) connected between pixel signal line 236 in the corresponding column and second node N2; a sixth switching element (transistor 255) connected between the first standard voltage line and second node N2; and a seventh switching element (transistor 256) connected between second node N2 and common node N3.

For example, as illustrated in FIGS. 6 and 7, in a first period (e.g., the Nth horizontal scanning period), first sample-and-hold circuit 241 generates the first differential voltage. In a second period after the first period (e.g., the N+1th horizontal scanning period), first sample-and-hold circuit 241 outputs the first differential voltage; the analog-to-digital conversion circuit (A/D conversion circuit 218) converts the first voltage that is based on the first differential voltage into a digital signal, the digital signal being one of the digital signals; and the second sample-and-hold circuit generates the second differential voltage. In a third period after the second period (e.g., the N+2th horizontal scanning period), second sample-and-hold circuit 242 outputs the second differential voltage; and the analog-to-digital conversion circuit (A/D conversion circuit 218) converts the second voltage that is based on the second differential voltage into a digital signal, the digital signal being one of the digital signals.

For example, as illustrated in FIGS. 1, 4, and 7, solid-state imaging device 200 includes reference voltage generation circuit 216 that generates reference voltage RAMP that monotonically increases or decreases. The analog-to-digital conversion circuit (A/D conversion circuit 218) includes comparator 261 that compares reference voltage RAMP with the first voltage and the second voltage; and counter 263 that generates the digital signals by counting, for each of the first voltage and the second voltage, a period until a result of comparison by comparator 261 changes. A period when reference voltage RAMP monotonically increases or decreases accounts for half or more of one horizontal scanning period.

For example, as illustrated in FIG. 1, imaging device 100 includes solid-state imaging device 200 described above and signal processing circuit 300 that processes digital signals output by solid-state imaging device 200. A plurality of pixels 211 include an optical black pixel that is shielded from light. Signal processing circuit 300 subtracts a first digital signal from a second digital signal. The first digital signal and the second digital signal are included in the digital signals output from solid-state imaging device 200. The first digital signal is based on a signal obtained from the optical black pixel. The second digital signal is based on a signal obtained from a pixel other than the optical black pixel among the plurality of pixels 211.

For example, as illustrated in FIG. 17, distance measurement device 400 includes light emitter 401 that emits light; solid-state imaging device 200 that receives reflected light of the light; and signal processing circuit 403 that processes digital signals output by solid-state imaging device 200. Signal processing circuit 403 generates a three-dimensional image including information in a depth direction by combining a plurality of images output from solid-state imaging device 200.

For example, each of the plurality of pixels 211 includes an avalanche photodiode and a pixel circuit capable of photon counting.

### Others

Note that the solid-state imaging device according to the present disclosure should not be limited to the above embodiments. The present disclosure includes other embodiments implemented by combining any structural elements in each of the embodiments, variations obtained by various changes and modifications to each of the embodiments that can be conceived by a person of ordinary skill in the art without departing from the scope of the present disclosure, and various devices including the solid-state imaging device according to the present disclosure.

Furthermore, the partitioning of functional blocks in the block diagrams is an example, and a plurality of functional blocks may be implemented as a single functional block, a single functional block may be divided into a plurality of functional blocks, and part of a function may be transferred to another functional block.

Furthermore, the processor included in each device according to the above embodiments is typically implemented as a large-scale integration (LSI) circuit, which is an integrated circuit. These processors may be individually configured as single chips or may be configured so that part or all of the processors are included in a single chip.

The method of circuit integration is not limited to LSI, and implementation through a dedicated circuit or a general-purpose processor is also possible. A field-programmable gate array (FPGA) that allows programming after LSI manufacturing or a reconfigurable processor that allows reconfiguration of the connections and settings of the circuit cells inside the LSI may also be used.

In each of the above embodiments, part of each structural element may be implemented by executing a software program suitable for the structural element. Each structural element may be implemented as a result of a program executor, such as a central processing unit (CPU) or processor, reading and executing a software program recorded on a recording medium such as a hard disk or semiconductor memory.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to solid-state imaging devices, imaging devices, and distance measurement devices.

1. A solid-state imaging device comprising:
a plurality of pixels that are arranged in a matrix and photoelectrically convert incident light;
a first sample-and-hold circuit that is provided per column and generates a first differential voltage, the first differential voltage being a difference between a first reset voltage and a first signal voltage that are output from a first pixel disposed in a corresponding column among the plurality of pixels;
a second sample-and-hold circuit that is provided per column and generates a second differential voltage, the second differential voltage being a difference between a second reset voltage and a second signal voltage that are output from a second pixel disposed in the corresponding column among the plurality of pixels, the second pixel being different from the first pixel; and
an analog-to-digital conversion circuit that is provided per column and converts a first voltage and a second voltage into digital signals, the first voltage being based on the first differential voltage output from the first sample-and-hold circuit disposed in the corresponding column, the second voltage being based on the second differential voltage output from the second sample-and-hold circuit disposed in the corresponding column.

2. The solid-state imaging device according to claim 1, comprising:
a standard voltage generation circuit that generates a first standard voltage and a second standard voltage, the first standard voltage corresponding to the first reset voltage and the second reset voltage and being input to the first sample-and-hold circuit and the second sample-and-hold circuit; and
an output circuit that generates the first voltage and the second voltage by offsetting the first differential voltage and the second differential voltage using the second standard voltage.

3. The solid-state imaging device according to claim 2, wherein
the output circuit includes:
a first switching element connected between (i) a common node to which the first differential voltage or the second differential voltage is selectively output and (ii) a second standard voltage line to which the second standard voltage is supplied; and
a buffer circuit including an input terminal connected to the common node and an output terminal connected to the analog-to-digital conversion circuit.

4. The solid-state imaging device according to claim 3, wherein
no capacitive element other than parasitic capacitance is connected to the common node.

5. The solid-state imaging device according to claim 3, comprising:
a pixel signal line that is provided per column and is connected to a plurality of pixels disposed in the corresponding column, wherein
the first sample-and-hold circuit includes:
a second switching element connected between the pixel signal line in the corresponding column and a first node;
a third switching element connected between a first standard voltage line to which the first standard voltage is supplied and the first node; and
a fourth switching element connected between the first node and the common node,
the second sample-and-hold circuit includes:
a fifth switching element connected between the pixel signal line in the corresponding column and a second node;
a sixth switching element connected between the first standard voltage line and the second node; and
a seventh switching element connected between the second node and the common node.

6. The solid-state imaging device according to claim 1, wherein
in a first period:
the first sample-and-hold circuit generates the first differential voltage,
in a second period after the first period:
the first sample-and-hold circuit outputs the first differential voltage;
the analog-to-digital conversion circuit converts the first voltage that is based on the first differential voltage into a digital signal, the digital signal being one of the digital signals; and
the second sample-and-hold circuit generates the second differential voltage, and
in a third period after the second period:
the second sample-and-hold circuit outputs the second differential voltage; and
the analog-to-digital conversion circuit converts the second voltage that is based on the second differential voltage into a digital signal, the digital signal being one of the digital signals.

7. The solid-state imaging device according to claim 1, comprising:
a reference voltage generation circuit that generates a reference voltage that monotonically increases or decreases, wherein
the analog-to-digital conversion circuit includes:
a comparator that compares the reference voltage with the first voltage and the second voltage; and
a counter that generates the digital signals by counting, for each of the first voltage and the second voltage, a period until a result of comparison by the comparator changes, and
a period when the reference voltage monotonically increases or decreases accounts for half or more of one horizontal scanning period.

8. An imaging device comprising:
the solid-state imaging device according to claim 1; and
a signal processing circuit that processes digital signals output by the solid-state imaging device, wherein
the plurality of pixels include an optical black pixel that is shielded from light, and
the signal processing circuit subtracts a first digital signal from a second digital signal, the first digital signal and the second digital signal being included in the digital signals output from the solid-state imaging device, the first digital signal being based on a signal obtained from the optical black pixel, the second digital signal being based on a signal obtained from a pixel other than the optical black pixel among the plurality of pixels.

9. A distance measurement device comprising:
a light emitter that emits light;
the solid-state imaging device according to claim 1 that receives reflected light of the light; and
a signal processing circuit that processes digital signals output by the solid-state imaging device, wherein
the signal processing circuit generates a three-dimensional image including information in a depth direction by combining a plurality of images output from the solid-state imaging device.

10. The distance measurement device according to claim 9, wherein
each of the plurality of pixels includes an avalanche photodiode and a pixel circuit capable of photon counting.
